(19) United States
(12) Patent Application Publication
(10) Pub. No.: US 2026/0362083 A1
(43) Pub. Date: Nov. 12, 2026

(54) NETWORK-DRIVEN DEVICE RESTRICTION BASED ON GEOFENCED LOCATIONS

(71) Applicant: T-Mobile USA, Inc., Bellevue, WA (US)

(72) Inventor: Matthew John Starzec, Leesburg, VA (US)

(21) Appl. No.: 19/200,130

(22) Filed: May 6, 2025

(51) Int. Cl. H04W 4/021; H04M 1/72463

(52) U.S. Cl. CPC H04W 4/021; H04M 1/72463

(57) ABSTRACT

A geofence-based application restriction system provides dynamic control over user application functionality on subscriber devices within defined geographic areas. In some examples, these solutions can enhance security and compliance at sensitive locations. An example system stores database records associating geofences, defined by cell site antenna sectors, with restriction policies for specific user applications such as camera or voice calling apps. In some examples, a geofence and corresponding restriction policy can be created by request from a third party, such as an entity owning or affiliated with the geographic area covered by the geofence. Upon receiving an indication of subscriber devices served by a relevant cell site antenna sector, the example system determines whether to apply the restriction policy and transmits trigger commands via the network to cause the devices to restrict specified applications. In some examples, the trigger command may be sent to a carrier operating system build.

### BACKGROUND

Modern wireless communication networks are equipped with technologies that enable the determination and tracking of mobile device locations. These capabilities have facilitated the development of location-based services, which have found applications in navigation, emergency response, and targeted advertising, among other fields.

Networks are also capable of delivering differentiated services to individual devices or groups of devices. Through advancements such as network slicing, network operators can tailor network performance and service features to meet specific requirements associated with various users or applications.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 depicts an example system for network-driven device restriction based on geofencing, according to some example implementations.

FIG. 4 is a flowchart of an example method for network-driven device restriction based on geofencing, according to some example implementations.

FIG. 5 is a block diagram that illustrates an example of a computing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides a system and method for restricting services on subscriber devices based on geofenced areas defined by cell site antenna sectors within a telecommunications network. By leveraging network-driven geofencing and policy enforcement, the present technology addresses challenges in controlling device behavior in sensitive or restricted environments.

Existing technologies in wireless communication networks can provide differentiated services by granting increased network access, enhanced bandwidth, or prioritized connectivity to certain devices via network slicing, for example. While these approaches focus on adding or improving network services, they do not address converse scenarios where it is desired to restrict or limit device applications or features. For example, it may be desired to restrict camera or recording functionality on subscriber devices during a presidential inauguration to enhance security, or to limit communication and media sharing capabilities during a confidential movie screening or product launch event to prevent unauthorized disclosures. Other scenarios may include restricting device features and applications in testing centers to prevent cheating, or in research and development facilities to safeguard proprietary information. Traditionally, organizations have faced difficulties in reliably enforcing service restrictions in locations where privacy, security, or operational control is paramount.

The present technology addresses these shortcomings by enabling network operators or authorized third parties to define geofenced areas and associated restriction policies that are automatically enforced on subscriber devices as they are served by designated cell site antenna sectors composing the geofenced areas. This network-centric approach ensures that restrictions are applied consistently and promptly, without requiring user intervention or specialized device software. Organizations can thereby safeguard sensitive environments, protect confidential information, and enhance public safety with greater reliability and administrative ease.

The present technology can be implemented by a restriction control server, which can reside within the core network, at the network edge or in an access network (e.g., coupled with a base station), or as a cloud-based service interfacing with the telecommunications infrastructure. The restriction control server can manage a database of geofence definitions and corresponding restriction policies and interface with the network to communicate with subscriber devices and enact those restriction policies. The server can monitor network data to identify devices served by the relevant cell site antenna sectors. The server can determine, based on policy criteria, whether a restriction should be applied to each device. When applicable, the server transmits trigger commands to affected devices, causing them to restrict specified user applications, such as those providing access to hardware features like cameras or microphones.

### Example Wireless Communications Systems

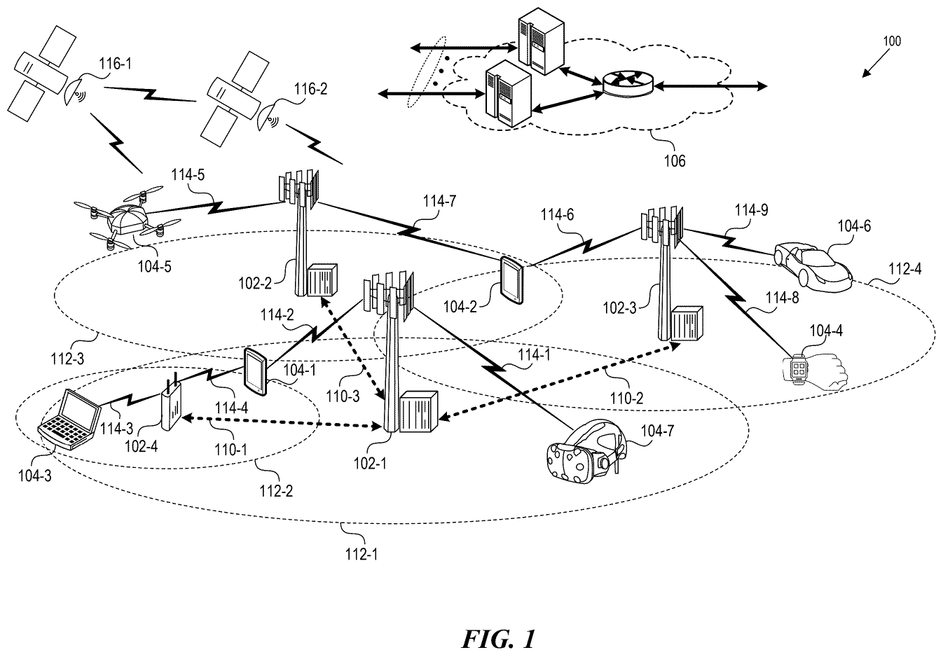

FIG. 1 is a block diagram that illustrates a wireless telecommunication network 100 (“network 100”) in which aspects of the disclosed technology are incorporated.
The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point. In some implementations, these base stations or NANs can multiple transmission-reception points (TRPs) and can be configured to transmit and receive signals via multiple beams.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc. These wireless devices can be mobile devices whose locations change over time.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example Core Network Systems

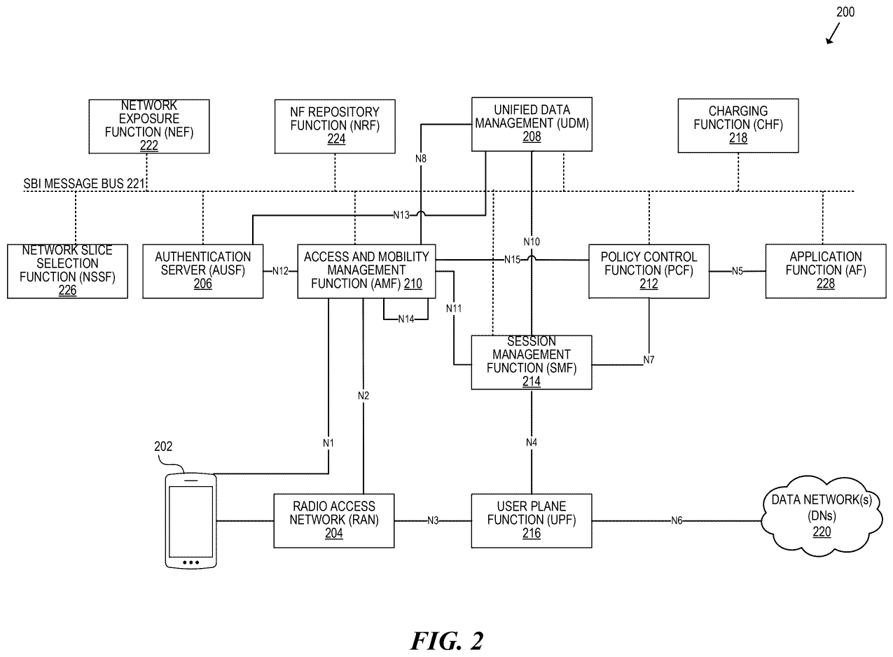

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations for Geofence-Based Device Restriction

Implementations described herein relate to automatically disabling or restricting subscriber device features, including specific applications, when a subscriber device enters into a predefined geofenced area. According to example implementations, a system uses cell site sector-based geofencing, and a restriction control server can enforce restriction policies via communication with the cell site, in some examples. For example, the server can instruct the cell site to restrict the subscriber device's functionality or control a user application on the subscriber device to block certain features.

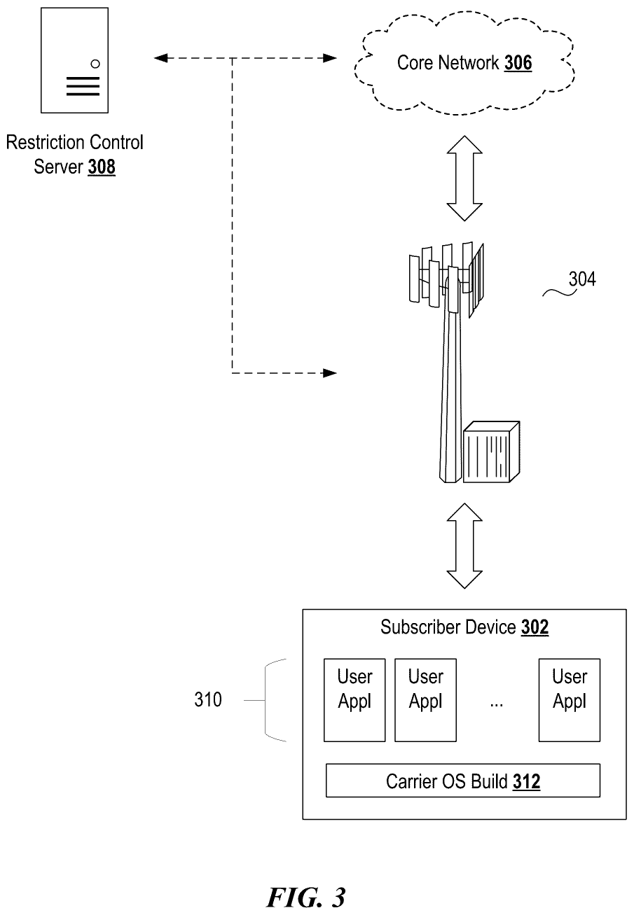

FIG. 3 illustrates an example system for network-drive device restriction based on geofencing. In particular, the example system of FIG. 3 is configured to enforce restrictions on a subscriber device 302 via a telecommunications network to which the subscriber device 302 is connected. The telecommunications network includes a base station 304 and a core network 306. Implementation and enforcement of geofence-based restriction policies for the subscriber device 302 can be driven by a restriction control server 308, which can be coupled with or implemented within the telecommunications network.

The subscriber device 302 may be any mobile device capable of wireless communication, such as a smartphone, tablet, laptop, wearable device, drone, or the like. Because the subscriber device 302 can be mobile in some examples, it can move into and out of various geographic areas. This mobility presents challenges for organizations seeking to control device functionality in sensitive or restricted environments, as described above. The present system addresses these challenges by enabling the network to automatically enforce restrictions on the subscriber device 302 as it enters or exits designated geofenced areas.

The subscriber device 302 communicates wirelessly with the base station 304, which serves as the access point to the telecommunications network. For simplicity, FIG. 3 depicts a single base station 304, though it will be understood that a typical network deployment includes many such base stations. Each base station 304 is configured to deploy a cell site, which is a geographic area of wireless coverage. The cell site is typically divided into multiple sectors, each sector representing a portion of the coverage area served by a directional antenna. In some examples, a cell site can include three sectors, six sectors, or nine sectors, and each sector provides coverage to a specific wedge-shaped region. In example implementations, a sector refers to a subdivision of a cell site, defined by the coverage area of a particular antenna or antenna array of the base station 304, and is a fundamental unit for defining geofenced areas in the present system.

In addition to being defined by physical location and antenna coverage, each sector of a cell site may be assigned one or more specific frequency bands or channels by the base station 304. This means that, while a sector is fundamentally a geographic subdivision, the network can further distinguish sectors by the frequencies over which they provide service. This assignment of frequencies to sectors enables more granular and flexible geofencing, as restrictions can be applied based on both the physical boundaries of a sector and the particular frequency resources allocated to it.

The base station 304 is coupled to the core network 306, which manages overall network operations and provides centralized control functions. The core network 306 can include certain network functions, such as those identified with FIG. 2, for generating, storing, and managing data related to subscriber device location, subscriber permissions or plan parameters, and other operational data. These network functions enable the core network 306 to support location-based services, enforce service policies, and coordinate with other network elements to deliver differentiated or restricted services to subscriber devices.

As illustrated in FIG. 3, the restriction control server 308 can be coupled to or implemented within the core network 306 in a variety of ways. In some implementations, the restriction control server 308 may be realized as an Application Function (AF) within the core network architecture. As an AF, the restriction control server 308 can interface with various core network functions, such as the Policy Control Function (PCF), the Network Exposure Function (NEF), and the Unified Data Management (UDM) function. For example, the restriction control server 308 may communicate with the PCF to enforce policy decisions related to device restrictions, interact with the NEF to access network events and exposure capabilities, and utilize the UDM to retrieve or update subscriber data relevant to geofence-based policies. In some implementations, the restriction control server 308 may be integrated into these example core network functions. Thus, the reference control server 308 as identified with FIG. 3 may be distributed across certain core network functions, in some implementations.

As further illustrated in FIG. 3, the restriction control server 308 can also be coupled to or implemented at the base station 304. In some examples, implementing the restriction control server 308 at the base station 304 can reduce latency in enforcing restrictions and provide localized decision-making and improved responsiveness to changes in device location within the coverage area of the base station. This approach may be particularly advantageous in scenarios requiring rapid or real-time enforcement of geofence-based policies, or where network resources at the edge are leveraged for distributed processing. Conversely, implementing the restriction control server 308 within the core network can facilitate centralized policy management, easier integration with subscriber data and network-wide functions, and simplified coordination across multiple base stations or geographic regions.

In some implementations, the restriction control server 308 can be provided as a cloud-based service that is coupled to the telecommunications network, for example, by interfacing with core network functions or access network elements via secure application programming interfaces (APIs) or service interfaces. In some examples, this cloud-based deployment enables scalable, flexible, and centralized management of geofence-based restriction policies, while also supporting integration with third-party systems or external policy management platforms.

The restriction control server 308 is configured to generate and store geofence database records, each record defining a geofence and including parameters for a corresponding restriction policy. According to certain implementations, third-party entities—such as event organizers, facility managers, or enterprise administrators—can request the generation of a geofence and associated restriction policy to be enforced at subscriber devices via the telecommunications network. Such requests may be submitted via an API or other network interface. The parameters for a restriction policy may include, for example, geofence boundaries (e.g., defined by cell site sectors, defined by geographical coordinates), subscriber information (e.g., device identifiers, user roles, subscriber rate plans), third-party identifiers (i.e., identifying a third-party entity that requested the geofence and restriction policy), time windows for enforcement, and the specific applications or features to be restricted.

In some implementations, the telecommunications network may support network slicing, wherein multiple logical networks—referred to as network slices—are instantiated over a shared physical infrastructure. Each network slice can be configured with specific characteristics, quality of service (QoS) parameters, and security policies tailored to particular use cases or subscriber groups. The restriction control server 308 may interact with the network slicing management functions of the core network 306 to enforce geofence-based restriction policies on a per-slice basis. For example, the restriction control server 308 can trigger restrictions that apply only to devices operating within a designated network slice, or can cause devices to be assigned to a particular slice when entering a geofenced area, thereby ensuring that only authorized services and applications are accessible. In some implementations, a restriction policy is configured to identify a particular network slice to which it applies.

The restriction control server 308 monitors network data to determine which subscriber devices 302 are located within a defined geofence. In some implementations, the restriction control server 308 may query the core network 306 at a time corresponding to, or shortly before, the start of a restriction enforcement window to obtain a current list of devices being served by particular cell site sectors or otherwise present within the geofenced area. This query-based approach enables the server to dynamically identify devices that are subject to upcoming restrictions. In other implementations, the restriction control server 308 may receive real-time updates or event notifications from the network regarding device location changes, or may periodically poll network functions for updated location information.

The restriction control server 308 further evaluates whether the restriction policy applies to each device, based on subscriber information (e.g., rate plan, subscriber demographic) or other policy criteria. Only those devices meeting the policy criteria and located within the geofenced area may be subject to the specified restrictions. In some implementations, the restriction control server 308 is configured to evaluate subscription threshold information when determining whether to enforce a restriction policy for a given subscriber device 302. For example, the restriction policy may specify that only devices associated with certain subscriber rate plans or service tiers are subject to geofence-based restrictions, while devices on other plans (such as premium or enterprise plans) or emergency devices are exempt. The restriction control server 308 can access subscriber plan information—such as rate plan identifiers or entitlement data—via the core network 306 or associated subscriber databases, and compare this information to the criteria defined in the restriction policy.

When a restriction is to be enforced, the restriction control server 308 communicates with the subscriber device 302 via the telecommunications network to trigger the restriction of device functionality or services. As shown in FIG. 3, the subscriber device 302 includes multiple user applications 310, which can include native or system applications such as a camera application, an audio recording application, a voice/video calling application (a dialer application), and/or the like. These examples of native applications involve usage of hardware features of the subscriber device, such as a camera or microphone, that could be used to collect observables in a secure environment. According to example implementations, usage of these hardware features can be restricted or limited based on restricting corresponding or related user applications 310.

In some examples, the subscriber device further includes a carrier operating system (OS) build 312. The carrier OS build 312 may include operating system components and carrier-specific modules that facilitate the receipt and enforcement of restriction commands from the network. In some implementations, the restriction control server 308 can transmit commands to the subscriber device 302 that can be processed by the carrier OS build 312 to control and restrict certain user applications 310 residing on the subscriber device 302, in accordance with the restriction policy.

Other mechanisms may be employed to disable or restrict user applications 310, depending on the capabilities of the subscriber device 302 and the network architecture. For example, the restriction control server 308 may communicate with device management agents, such as Mobile Device Management (MDM) clients or enterprise mobility management (EMM) solutions, which are installed on the subscriber device 302 and can enforce application-level or system-level restrictions in response to network commands. In some implementations, a trusted execution environment (TEE) or secure element on the device may be leveraged to enforce restrictions at the hardware or operating system level, providing a higher degree of security and tamper resistance.

In some examples, the restriction control server 308 may interact with application-layer controls, such as software development kits (SDKs) that are integrated into user applications 310. These SDKs can receive and process restriction commands from the network, enabling fine-grained control over application functionality, such as disabling specific features or access to device hardware (e.g., camera or microphone) when a restriction is in effect. In further implementations, the restriction control server 308 may utilize network entitlement APIs, which allow the network to control data traffic within the network associated with specific applications or services on the device, based on the current geofence and policy parameters. Each of these mechanisms may involve a different communication protocol or enforcement pathway, but generally, the restriction control server 308 can initiate the restriction by transmitting a trigger command through the telecommunications network, either directly or via the core network 306 or base station 304, to the subscriber device 302 or the relevant enforcement component.

The effect of restricting or disabling a user application 310 is to prevent the subscriber device 302 from accessing certain functionalities, such as the camera, microphone, or communication services, while the restriction is in effect. In some implementations, the subscriber device 302 may display a notification to the user indicating that a restriction has been applied, may request user permission to enforce the restriction, or may present an offer or explanation related to the restriction.

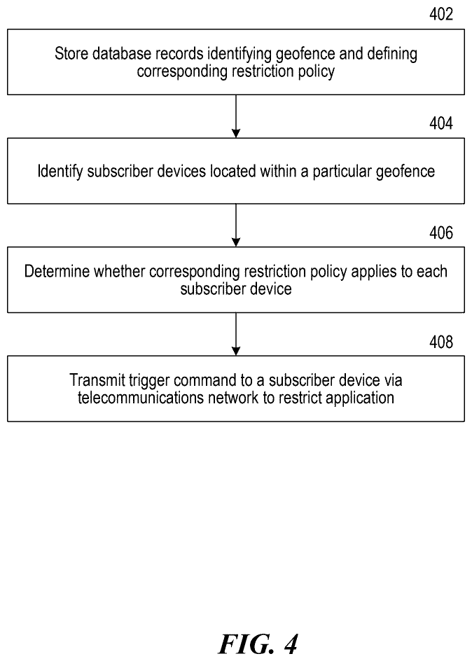

FIG. 4 is a flowchart including example operations for network-driven device restriction based on geofencing, as described in the present disclosure. These operations may be performed by a system coupled with or implemented within a telecommunications network, such as a restriction control server according to the description above.

At 402, the system stores database records identifying a geofence and defining a corresponding restriction policy. This step may involve receiving geofence creation requests from third-party entities (e.g., event organizers, facility managers, enterprise administrators) via an API or other network interface. The stored records may include geofence boundaries, time windows for enforcement, subscriber information (such as device identifiers, user roles, or rate plans), and the specific applications or device features to be restricted. Other policy parameters can include subscription threshold information, network slice identifiers, and third-party identifiers. In some implementations, the database records can be stored remotely (e.g., in the network, in a cloud-based service), and the system can access the database records.

At 404, the system identifies subscriber devices located within a particular geofence. This may be accomplished by querying the core network for a list of devices currently being served by cell site sectors or access points corresponding to the geofence, or by receiving real-time location updates or event notifications from the network. The timing of this operation can be aligned with the start of a restriction enforcement window to ensure up-to-date device location information.

At 406, the system determines whether the corresponding restriction policy applies to each subscriber device. This determination may be based on evaluating subscriber information, such as rate plan or subscription threshold information, user roles, or other policy criteria defined in the restriction policy. For example, the system may access subscriber databases or entitlement management functions to verify whether a device is associated with a rate plan or service tier that is subject to the restriction. The system may also consider network slice assignment when identifying devices, ensuring that restrictions are applied only to devices operating within a designated network slice if specified by the policy. Only those devices that meet the policy criteria and are located within the geofence may be selected for enforcement of the restriction.

At 408, the system transmits a trigger command to a subscriber device via the telecommunications network to restrict an application. The trigger command may be delivered through various network pathways, such as via the core network, base station, or cloud-based service, and may be received by the device's operating system (which can be a specific build associated with the network operator or carrier), device management agent, trusted execution environment, or application-layer SDK. Upon receipt, the subscriber device enforces the restriction by disabling or limiting the specified application or device feature, such as the camera, microphone, or communication services, in accordance with the restriction policy. In some implementations, the device may also display a notification to the user indicating that a restriction has been applied.

### Example Computing Systems

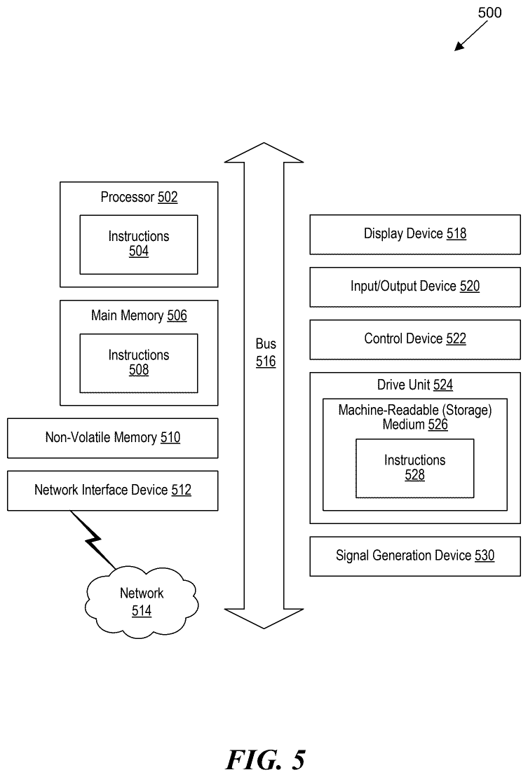

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for geofence-based application service restriction via a telecommunications network, the system comprising:
at least one processor; and
at least one memory storing instructions that, when executed by the at least one processor, cause the system to implement operations comprising:
generating a plurality of database records each identifying a geofence defined by at least one cell site antenna sector of the telecommunications network,
wherein each database record includes a restriction policy specifying one or more user applications to be restricted on subscriber devices, and
wherein at least one of the database records is generated and stored in response to a request to establish the restriction policy from a third party associated with a geographic area covered by a respective cell site antenna sector;
receiving, from the telecommunications network, an indication that identifies a set of subscriber devices being served by a particular cell site antenna sector corresponding to a particular geofence identified by a particular database record;
determining, for each subscriber device in the set, whether to apply the restriction policy associated with the particular geofence based on evaluating subscriber information associated with the subscriber device and subscription threshold information specified with the restriction policy in the particular database record; and
transmitting, via the telecommunications network, a trigger command to at least one subscriber device in the set, the trigger command configured to cause the subscriber device to restrict a particular user application residing on the subscriber device, wherein the particular user application is an application that provides access to a hardware feature of the subscriber device.

2. The system of claim 1, wherein the particular user application comprises a native application that is a camera application, a voice calling application, a video calling application, or an audio recording application.

3. The system of claim 1, wherein the indication that identifies the set of subscriber devices is received in response to the system transmitting a query to the telecommunications network in connection to a starting time for the restriction policy, the starting time being specified in the particular database record.

4. The system of claim 1, wherein the trigger command is transmitted to a carrier operating system (OS) build executing on the at least one subscriber device.

5. The system of claim 1, wherein the trigger command is further configured to cause the at least one subscriber device to display a notification that indicates the restriction policy associated with the particular geofence.

6. A method for geofence-based application service restriction via a telecommunications network, comprising:
generating a plurality of database records each identifying a geofence defined by at least one cell site antenna sector of a telecommunications network, wherein each database record includes a restriction policy specifying one or more user applications to be restricted on subscriber devices;
receiving, from the telecommunications network, an indication identifying a set of subscriber devices being served by a particular cell site antenna sector corresponding to a particular geofence identified by a particular database record; and
transmitting, via the telecommunications network, a trigger command to at least one subscriber device in the set, the trigger command configured to cause the subscriber device to restrict at least one user application residing on the subscriber device in accordance with the restriction policy associated with the particular geofence.

7. The method of claim 6, wherein at least one of the database records is generated and stored in response to a request to establish the restriction policy from a third party associated with a geographic area covered by a respective cell site antenna sector.

8. The method of claim 6, further comprising:
determining, for each subscriber device in the set, whether to apply the restriction
policy associated with the particular geofence based on evaluating subscriber information associated with the subscriber device and subscription threshold information specified with the restriction policy in the particular database record.

9. The method of claim 6, wherein the at least one user application comprises a native application that is a camera application, a voice calling application, a video calling application, or an audio recording application.

10. The method of claim 8, wherein the indication that identifies the set of subscriber devices is received in response to transmitting a query to the telecommunications network in connection to a starting time for the restriction policy, the starting time being specified in the particular database record.

11. The method of claim 8, wherein the trigger command is transmitted to a carrier operating system (OS) build executing on the at least one subscriber device.

12. The method of claim 8, wherein the trigger command is further configured to cause the at least one subscriber device to display a notification that indicates the restriction policy associated with the particular geofence.

13. The method of claim 8, wherein the restriction policy for a given geofence identifies a specific network slice for which the restriction policy is applied.

14. At least one non-transitory computer-readable medium storing instructions that, when executed by at least one processor, cause the at least one processor to perform operations comprising:
accessing a plurality of database records each identifying a geofence defined by at least one cell site antenna sector of a telecommunications network, wherein each database record includes a restriction policy specifying one or more user applications to be restricted on subscriber devices;
receiving, from the telecommunications network, an indication identifying a set of subscriber devices being served by a particular cell site antenna sector corresponding to a particular geofence identified by a particular database record; and
transmitting, via the telecommunications network, a trigger command to at least one subscriber device in the set, the trigger command configured to cause the subscriber device to restrict at least one user application residing on the subscriber device in accordance with the restriction policy associated with the particular geofence.

15. The at least one non-transitory computer-readable medium of claim 14, wherein at least one of the database records is generated and stored in response to a request to establish the restriction policy from a third party associated with a geographic area covered by a respective cell site antenna sector.

16. The at least one non-transitory computer-readable medium of claim 14, wherein the operations further comprise:
determining, for each subscriber device in the set, whether to apply the restriction policy associated with the particular geofence based on evaluating subscriber information associated with the subscriber device and subscription threshold information specified with the restriction policy in the particular database record.

17. The at least one non-transitory computer-readable medium of claim 14, wherein the at least one user application comprises a native application that is a camera application, a voice calling application, a video calling application, or an audio recording application.

18. The at least one non-transitory computer-readable medium of claim 14, wherein the at least one user application comprises a native application that is a camera application, a voice calling application, a video calling application, or an audio recording application.

19. The at least one non-transitory computer-readable medium of claim 14, wherein the indication that identifies the set of subscriber devices is received in response to transmitting a query to the telecommunications network in connection to a starting time for the restriction policy, the starting time being specified in the particular database record.

20. The at least one non-transitory computer-readable medium of claim 14, wherein the trigger command is transmitted to a carrier operating system (OS) build executing on the at least one subscriber device.
